(19) United States
(12) Patent Application Publication
(10) Pub. No.: US 2026/0367640 A1
(43) Pub. Date: Nov. 19, 2026

(54) System and method suitable for controlling an autonomous agent to acquire information from at least one target in an environment

(71) Applicant: Mitsubishi Electric Research Laboratories, Inc., Cambridge, MA (US)

(72) Inventors: Stefano Di Cairano, Newton, MA (US); Samet Uzum, Seattle, WA (US)

(73) Assignee: Mitsubishi Electric Research Laboratories, Inc., Cambridge, MA (US)

(21) Appl. No.: 19/316,046

(22) Filed: Sep. 2, 2025

Related U.S. Application Data
(60) Provisional application No. 63/802,145, filed on May 8, 2025.

(51) Int. Cl. G05D 1/644; B63B 79/40; B64U 10/14; B64U 20/87; G05D 105/80; G05D 107/70; G05D 109/10; G05D 109/20; G05D 109/30

(52) U.S. Cl. CPC G05D 1/644; B63B 79/40; B64U 10/14; B64U 20/87; G05D 2105/80; G05D 2107/70; G05D 2109/10; G05D 2109/20; G05D 2109/38

(57) ABSTRACT

The present disclosure provides a method for controlling an autonomous agent to acquire information from at least one target. The method includes defining an information acquisition metric configured to indicate a non-zero value when physical sensing constraints are satisfied and applying temporal conditions on the information acquisition metric, the one or more temporal conditions indicating that the information acquisition metric is to satisfy the one or more physical sensing constraints over a time interval. The method further includes formulating and solving a trajectory optimization problem subject to constraints to determine a motion plan for the autonomous agent, wherein the constraints include a motion constraint of the autonomous agent, a terminal condition based on an accumulated value of the information acquisition metric, and the temporal conditions. The method further includes controlling the autonomous agent based on the motion plan to acquire the information from the at least one target.

### TECHNICAL FIELD

The present disclosure relates generally to control systems, and more specifically to a system and a method suitable for controlling an autonomous agent to acquire information from at least one target in an environment.

### BACKGROUND

An autonomous agent, such as an unmanned aerial vehicle (UAV), an autonomous ground vehicle, or an autonomous underwater vehicle, is increasingly deployed for information acquisition tasks in industrial, commercial, and environmental domains. Example applications include inspection of infrastructure assets in plants, refineries, and warehouses; monitoring of pipelines and subsea structures; and surveillance or reconnaissance in outdoor environments. In these contexts, the autonomous agent acquires information from spatially distributed targets using onboard sensors such as cameras, LiDARs, radars, ultrasonic sensors, gas sensors, or hyperspectral imagers.

Conventional motion planning approaches for the autonomous agent treat trajectory generation independently of sensing requirements. Such approaches typically optimize trajectories for objectives such as minimizing travel time, energy consumption, or distance, while treating the sensing requirements only as secondary constraints. While adequate for navigation alone, these approaches fail to ensure that the autonomous agent acquires usable information from the targets. For instance, passing near a target may not yield valid data unless the autonomous agent also satisfies the sensing requirements such as maintaining the target within a sensor range, aligning with an appropriate orientation or acquisition direction, and keeping the target inside a field of view of the onboard sensors.

Further, the environments in which the autonomous agent operates are often large, remote, or difficult for human operators to access directly. In such scenarios, autonomous operation and reliable, precomputed trajectory planning are desirable, particularly when timely or repeated data collection is required. These environments may also include regions with restricted maneuverability or uncertain physical conditions, further underscoring the importance of planning trajectories that enable efficient and dependable information acquisition.

In view of these challenges, there is a need for motion planning methodologies that incorporate the sensing requirements while ensuring that the resulting trajectories remain compatible with physical capabilities of the autonomous agent.

### SUMMARY

Some embodiments are based on the recognition that an autonomous agent performing information acquisition, such as an aerial robot tasked with monitoring distributed targets, is subject to physical sensing constraints that limit where and how useful data can be collected. The physical sensing constraints include a sensing range, an acquisition direction, and a field-of-view geometry. Collectively, these physical sensing constraints define feasible regions of the autonomous agent's state space in which an information acquisition metric is non-zero, while outside the feasible regions the information acquisition metric evaluates to zero.

Some embodiments are based on the recognition that the feasible regions are typically nonlinear and fragmented, rather than convex or uniformly distributed. This creates difficulties for conventional gradient-based trajectory optimization methods, which rely on smooth, non-zero derivatives of an objective function. In regions where the information acquisition metric evaluates constantly to zero, gradients with respect to state and control variables are also zero, producing flat optimization landscapes. In such regions, the optimization methods become insensitive to trajectory changes and may fail to converge.

Moreover, acquiring information is not achieved by briefly entering the feasible regions defined by the information acquisition metric. In many scenarios, the autonomous agent must maintain sensor alignment with a target for a finite duration to collect sufficient data. Accordingly, temporal feasibility plays a role as significant as spatial feasibility. Representing the physical sensing constraints as time-bounded logical conditions provides a mechanism to capture requirements such as “the autonomous agent must remain aligned with the target for at least a specified interval.”

To express such temporal conditions, some embodiments employ Signal Temporal Logic (STL) specification. STL specification enables sensing feasibility to be modeled as logical predicates—such as the target being within the field of view, within the sensing range, or at an acceptable acquisition angle—that must hold over defined temporal intervals. By doing so, STL specification specifies mission windows during which the information acquisition metric remains non-zero and differentiable. This mitigates the zero-gradient issue and improves a stability of the optimization methods.

Some embodiments are further based on the realization that, due to tight coupling between the autonomous agent's motion (position, orientation, translational speed and rotational speed) and the physical sensing constraints, motion planning and information acquisition planning are not independent problems. Rather, they are interdependent components of a unified control task. Attempting to plan trajectories first and imposing the physical sensing constraints afterward may lead to infeasible or inefficient solutions. As such, it may be advantageous to formulate a joint planning framework, where trajectory generation and sensing feasibility are considered together during optimization.

To enable trajectory generation and sensing feasibility within a tractable optimization framework, some embodiments employ a generalized mean-based smooth robustness (GMSR) measure to parameterize the STL specification in a differentiable form. This parameterization allows the temporal conditions associated with the information acquisition metric to be embedded directly into a continuous-time optimal control problem. The continuous-time optimal control problem is solved using a continuous-time successive convexification approach, which iteratively solves convex subproblems to approximate the continuous-time optimal control formulation.

Accordingly, by addressing the structural challenges of zero-gradient regions, incorporating temporal feasibility, and unifying trajectory generation and sensing feasibility in a single optimization framework, the disclosed embodiments provide an approach that improves mission efficiency, robustness to constraint violations, and convergence of the optimization methods.

Accordingly, one embodiment discloses a system for controlling an autonomous agent to acquire information from at least one target in an environment. The system comprises a processor, and a memory having instructions stored thereon that, when executed by the processor, cause the system to: define an information acquisition metric that is a function of a state of the autonomous agent and is configured to indicate a non-zero value when one or more physical sensing constraints are satisfied, the one or more physical sensing constraints comprising at least one of a range constraint, an acquisition direction constraint, or a field of view constraint; apply one or more temporal conditions on the information acquisition metric, the one or more temporal conditions indicating that the information acquisition metric is to satisfy the one or more physical sensing constraints over a time interval; formulate and solve a trajectory optimization problem subject to constraints to determine a motion plan for the autonomous agent, wherein the constraints include a motion constraint associated with the autonomous agent, a terminal condition based on an accumulated value of the information acquisition metric, and the one or more temporal conditions; and control, based on the motion plan, the autonomous agent in the environment to acquire the information from the at least one target in the environment.

Accordingly, another embodiment discloses a method for controlling an autonomous agent to acquire information from at least one target in an environment. The method comprises defining an information acquisition metric that is a function of a state of the autonomous agent and is configured to indicate a non-zero value when one or more physical sensing constraints are satisfied, the one or more physical sensing constraints comprising at least one of a range constraint, an acquisition direction constraint, or a field of view constraint; applying one or more temporal conditions on the information acquisition metric, the one or more temporal conditions indicating that the information acquisition metric is to satisfy the one or more physical sensing constraints over a time interval; formulating and solving a trajectory optimization problem subject to constraints to determine a motion plan for the autonomous agent, wherein the constraints include a motion constraint associated with the autonomous agent, a terminal condition based on an accumulated value of the information acquisition metric, and the one or more temporal conditions; and controlling, based on the motion plan, the autonomous agent in the environment to acquire the information from the at least one target in the environment.

Accordingly, yet another embodiment discloses a non-transitory computer-readable storage medium embodied thereon a program executable by a processor for performing a method for controlling an autonomous agent to acquire information from at least one target in an environment. The method comprises defining an information acquisition metric that is a function of a state of the autonomous agent and is configured to indicate a non-zero value when one or more physical sensing constraints are satisfied, the one or more physical sensing constraints comprising at least one of a range constraint, an acquisition direction constraint, or a field of view constraint; applying one or more temporal conditions on the information acquisition metric, the one or more temporal conditions indicating that the information acquisition metric is to satisfy the one or more physical sensing constraints over a time interval; formulating and solving a trajectory optimization problem subject to constraints to determine a motion plan for the autonomous agent, wherein the constraints include a motion constraint associated with the autonomous agent, a terminal condition based on an accumulated value of the information acquisition metric, and the one or more temporal conditions; and controlling, based on the motion plan, the autonomous agent in the environment to acquire the information from the at least one target in the environment.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1 illustrates an example of monitoring operation in an environment, according to some embodiments of the present disclosure.

FIG. 2A illustrates a block diagram of a system for motion planning and controlling of an autonomous agent to perform an information acquisition task, according to some embodiments of the present disclosure.

FIG. 2B illustrates the functions executed by the system to control the autonomous agent to acquire the information from targets, according to some embodiments of the present disclosure.

FIG. 2C illustrates physical sensing constraints, according to some embodiments of the present disclosure.

FIG. 2D illustrates a trajectory determined without enforcing temporal conditions on an information acquisition metric.

FIG. 2E illustrates a trajectory determined with the temporal conditions enforced on the information acquisition metric, according to some embodiments of the present disclosure.

FIG. 3A illustrates the information acquisition metric, according to some embodiments of the present disclosure.

FIG. 3B illustrates an example plot of a component function of the information acquisition metric, according to some embodiments.

FIG. 3C illustrates a result of applying a smooth activation function to the component function, according to some embodiments.

FIG. 3D illustrates an implementation of the smooth activation function, according to some embodiments of the present disclosure.

FIG. 4 illustrates a block diagram for solving an optimization problem using a successive convexification approach, according to some embodiments of the present disclosure.

FIG. 5 illustrates an embodiment of the system applied in an industrial inspection use case, according to some embodiments of the present disclosure.

FIG. 6 illustrates an embodiment of the system applied in an underwater inspection use case, according to some embodiments of the present disclosure.

FIG. 7 illustrates an embodiment of the system applied in a warehouse inventory management use case, according to some embodiments of the present disclosure.

FIG. 8 is a schematic illustrating by non-limiting example a computing apparatus for implementing the methods and the systems of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

Autonomous agents are increasingly deployed in monitoring applications across a variety of domains, including infrastructure inspection, industrial facility surveillance, and asset tracking. For example, in the context of monitoring an industrial plant, a drone may be tasked with inspecting equipment zones, perimeter areas, or hazardous locations to collect visual, thermal, or gas sensor data. In such applications, acquiring information from specific targets dispersed across the industrial plant is desired to achieve inspection and safety objectives.

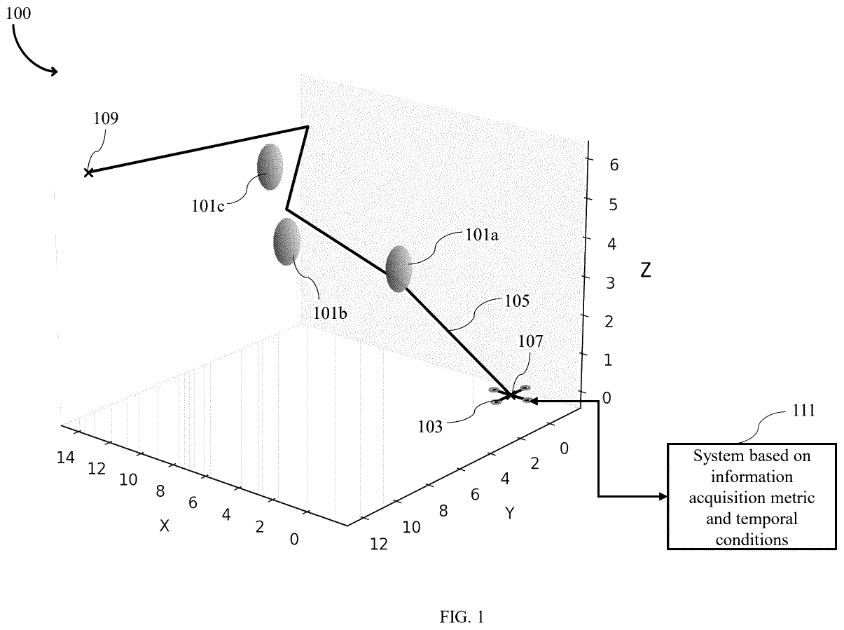

FIG. 1 illustrates an example of monitoring operation in an environment 100, according to some embodiments of the present disclosure. The environment 100 refers to a three-dimensional physical or simulated space in which an autonomous agent 103 operates. The environment 100 may be a structured setting, such as an industrial facility, a warehouse, or an inspection site, or an unstructured setting, such as an outdoor area, terrain, or airspace. The environment 100 may be static or dynamic and modeled using spatial coordinates such as Cartesian (X, Y, Z) or geodetic frames. The environment 100 includes one or more targets or regions of interest from which information is to be acquired, as well as obstacles, waypoints, or terrain features. For instance, the environment 100 includes targets 101a, 101b, and 101c, which are spatially distributed within the environment 100.

The autonomous agent 103 refers to a mobile robotic platform capable of navigating through the environment 100 without continuous human control, and configured to perform information acquisition tasks. The autonomous agent 103 may include an aerial vehicle (e.g., drone or UAV), ground vehicle (e.g., wheeled or tracked robot), marine vehicle, or other mobile robot. The autonomous agent 103 may include a computing system, motion actuators, a localization system (e.g., GPS, IMU), and on-board sensor(s). The term “on-board sensors” refers to sensing devices integrated with the autonomous agent 103, used to acquire information from the targets 101a-101c. The on-board sensors may include optical cameras (e.g., RGB, thermal, stereo), LiDARs, radars, ultrasonic sensors, gas sensors, hyperspectral imagers, or other data collection instruments. The autonomous agent 103 is configured to acquire information of the targets 101a-101c using one or more on-board sensors to perform the monitoring or inspection operation.

To enable effective monitoring, the autonomous agent 103 is desired to follow a trajectory 105 from an initial location 107 to a final location 109, visiting a set of intermediate locations along the trajectory 105 to acquire information about the targets 101a-101c. Embodiments of the present disclosure provide a system 111 for perception-aware motion planning based on a specific information acquisition metric and temporal conditions. The perception-aware motion planning is a process of designing autonomous agent's trajectory so that the autonomous agent 103 moves efficiently and collects useful information from its one or more on-board sensors.

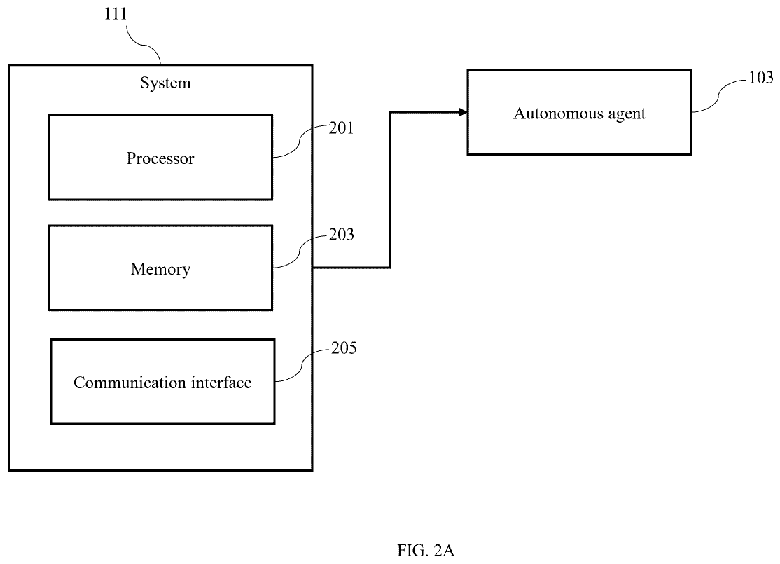

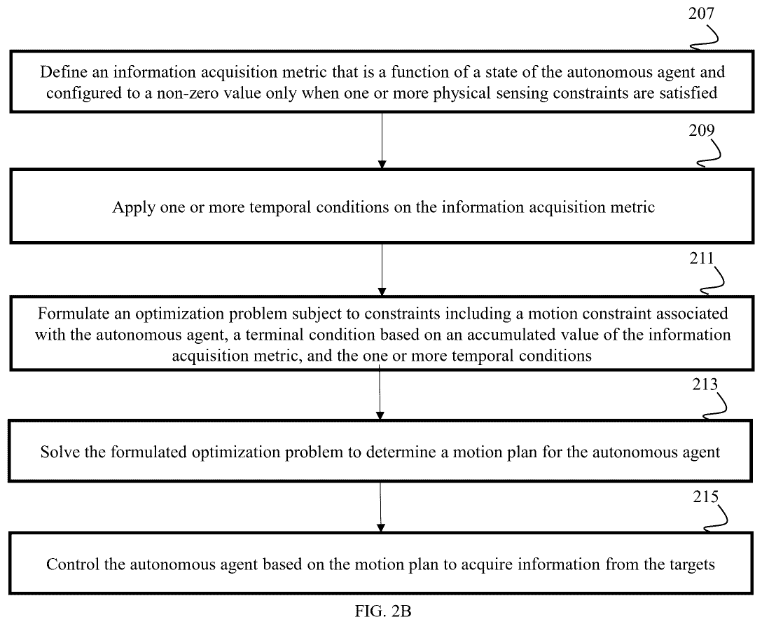

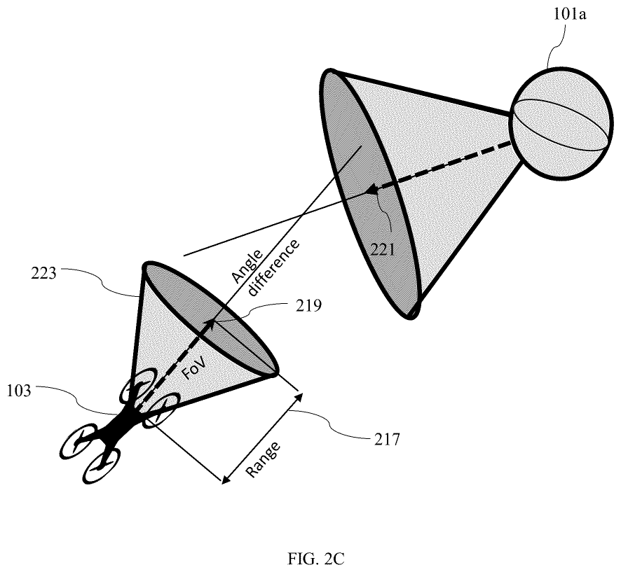

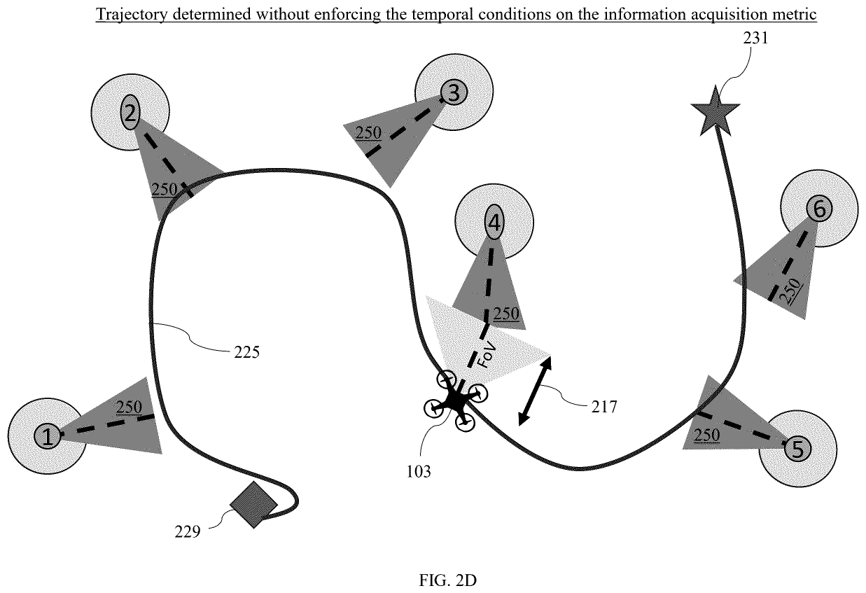

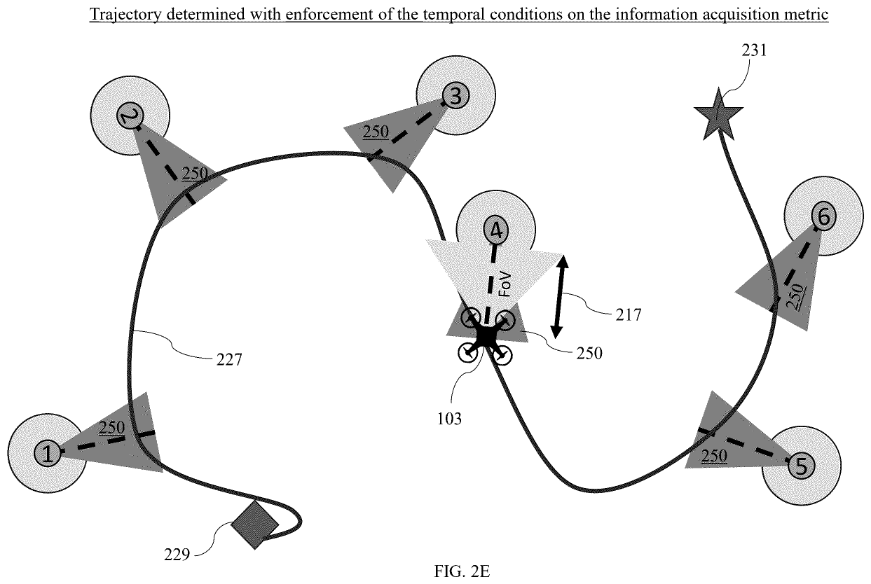

FIG. 2A illustrates a block diagram of the system 111 for motion planning and controlling of the autonomous agent 103 to perform the information acquisition task, according to some embodiments of the present disclosure. The system 111 is communicatively coupled to the autonomous agent 103. The system 111 includes a processor 201, a memory 203, and a communication interface 205. The processor 201 may be a single core processor, a multi-core processor, a computing cluster, or any number of other configurations. The memory 203 may include random access memory (RAM), read only memory (ROM), flash memory, or any other suitable memory systems. Additionally, in some embodiments, the memory 203 may be implemented using a hard drive, an optical drive, a thumb drive, an array of drives, or any combinations thereof.

The communication interface 205 may be any means such as a device or circuitry embodied in either hardware or a combination of hardware and software that is configured to receive and/or transmit data from/to other electronic devices in communication with the system 111. In this regard, the communication interface 205 may include, for example, an antenna (or multiple antennas) and supporting hardware and/or software for enabling communications with a plurality of different types of networks, such as first and second types of networks. Additionally or alternatively, the communication interface 205 may include the circuitry for interacting with the antenna(s) to cause transmission of signals via the antenna(s) or to handle receipt of signals received via the antenna(s).

Further, the memory 203 includes instructions stored thereon that, when executed by the processor 201, cause the processor 201 to execute functions to control the autonomous agent 103 to acquire information from the targets 101a-103c.

FIG. 2B illustrates the functions executed by the processor 201 to control the autonomous agent 103 to acquire the information from the targets 101a-103c, according to some embodiments of the present disclosure. At block 207, the processor 201 is configured to define an information acquisition metric that is a function of a state of the autonomous agent 103 and configured to a non-zero value when one or more physical sensing constraints are satisfied. The term “state of the autonomous agent” refers to a set of variables that fully describe a configuration and motion of the autonomous agent at a given time. The state may include, but is not limited to, the agent's position in space (e.g., in Cartesian or geodetic coordinates), velocity, orientation (e.g., heading, pitch, roll, or attitude represented via Euler angles, quaternions, or rotation matrices), orientation rate (e.g., heading rate, pitch rate, roll rate, or attitude rate) and optionally higher-order derivatives such as acceleration or angular acceleration.

Some embodiments are based on the recognition that accomplishing the information acquisition task presents several technical challenges. For instance, passing near a target is often insufficient—the autonomous agent 103 must satisfy the one or more physical sensing constraints during fly-by. These physical sensing constraints are described below in FIG. 2C.

FIG. 2C illustrates the physical sensing constraints, according to some embodiments of the present disclosure. For the purpose of explanation, the target 101a is considered here. The physical sensing constraints include a range constraint, an acquisition direction constraint, and/or a field of view constraint. The range constraint defines a sensing range 217 within which the target 101a must lie relative to the autonomous agent 103 in order to be considered observable or measurable by a sensor mounted on the autonomous agent 103. The range constraint is satisfied when a distance between a position of the autonomous agent 103 and a position of the target 101a is less than or equal to the sensing range 217.

The acquisition direction constraint specifies an angular condition between a direction 219 from the autonomous agent 103 to the target 101a and a predefined acquisition direction 221 associated with the target 101a. The acquisition direction constraint is satisfied when an angle between (i) the direction 219 from the autonomous agent 103 to the target 101a and (ii) the target's predefined acquisition direction 221 lies within a predefined angular range.

The field of view constraint defines a geometric visibility condition requiring that the target 101a be located within a predefined angular range defining a field of view 223 (FoV) of the autonomous agent 103. The field of view is represented as a conical region originating at the autonomous agent 103. The field of view constraint is satisfied when the target 101a lies within the predefined angular range defining the field of view 223.

Satisfying the physical sensing constraints, namely, the range constraint, the acquisition direction constraint, and the field of view constraint, provides several technical effects that improve the reliability, effectiveness, and applicability of autonomous information acquisition. First, by enforcing the range constraint, the system 100 ensures that the targets are sensed only when they lie within a distance at which the one or more on-board sensors can acquire usable data, thereby avoiding degraded or noisy measurements and preventing wasteful sensing attempts beyond the on-board sensor's effective range. Second, the acquisition direction constraint guarantees that the autonomous agent 103 observes each target from a geometrically suitable orientation, improving data quality by avoiding occlusions, perspective distortions, or unfavorable viewing angles. Third, the field of view constraint ensures that the targets are truly visible and observable at the time of sensing, rather than being assumed to be sensed based solely on distance or alignment. The combined enforcement of these physical sensing constraints enables robust and accurate information gathering during dynamic motion, particularly in scenarios where the autonomous agent 103 performs a fly-by without hovering.

Referring back to FIG. 2B, at block 207, the defined information acquisition metric is configured to indicate a non-zero value when the one or more physical sensing constraints are satisfied. Conventional trajectory planning methods for autonomous agents often focus on satisfying the physical sensing constraints at discrete points in time (e.g., snapshot visibility). However, for many real-world sensing tasks—such as inspection, monitoring, or tracking—momentary visibility is insufficient. The targets 101a-101c must be observed in a manner that is persistent, durational, or timed to specific mission phases. For example, a camera-equipped drone inspecting a valve or gauge in an industrial facility must maintain sufficient view of the valve/gauge for several seconds to ensure clear image capture and sensor integration. A brief fly-by that meets the physical sensing constraints only instantaneously is likely to yield incomplete or unusable data.

To address this limitation, at block 209, the processor 201 is configured to apply one or more temporal conditions on the information acquisition metric. The one or more temporal conditions govern not just whether a target is observable at a given time, but how long or when the physical sensing constraints must be satisfied over a time interval. In other words, the temporal conditions indicate that the information acquisition metric is to satisfy the one or more physical sensing constraints over the time interval. The one or more temporal conditions on the information acquisition metric ensure that the system 111 plans a motion plan that provide sustained information acquisition, rather than brief or incidental visibility.

Some embodiments are further based on the realization that, due to tight coupling between the autonomous agent's 103 motion (position, orientation, speed) and the physical sensing constraints, motion planning and information acquisition planning are not independent problems. Rather, motion planning and information acquisition planning are interdependent components of a unified control task. Attempting to plan trajectories first and imposing the physical sensing constraints afterward may lead to infeasible or inefficient solutions. As such, it may be advantageous to formulate a joint planning framework, where trajectory generation and sensing feasibility are considered together during optimization.

To this end, at block 211, the processor 201 is configured to formulate an optimization problem subject to constraints. The constraints include a motion constraint associated with the autonomous agent, a terminal condition based on an accumulated value of the information acquisition metric, and the one or more temporal conditions. The motion constraint may include kinematic constraints (e.g., maximum velocity, angular rate), dynamic constraints (e.g., acceleration or thrust limits), and safety constraints (e.g., collision avoidance, restricted zones). The motion constraints ensure that any trajectory computed for the autonomous agent 103 is physically feasible given the autonomous agent's capabilities and complies with environmental or mission-specific limitations.

At block 213, the processor 201 is configured to solve the formulated optimization problem to determine a motion plan for the autonomous agent 103. The motion plan includes a trajectory and a set of control inputs configured to execute the trajectory. The trajectory represents a time-varying state of the autonomous agent 103 over a mission time interval. For example, the trajectory may include the autonomous agent's 103 positions, orientations, linear velocities, angular velocities, and/or other system variables that describe the configuration and motion of the autonomous agent 103 over the mission time interval. The term “mission time interval” refers to a continuous time domain over which the trajectory is executed by the autonomous agent 103. The control inputs correspond to actuation commands such as thrust forces, torques, steering angles, or motor signals that are applied to one or more actuators of the autonomous agent 103 to execute the trajectory included in the motion plan.

The formulated optimization problem includes the terminal condition based on the accumulated value of the information acquisition metric. This terminal condition requires the accumulated value of the information acquisition metric to exceed a predefined threshold at the end of the trajectory. The information acquisition metric is non-zero when the one or more physical sensing constraints are satisfied. Accumulating the values of the information acquisition metric over time allows the system 111 to quantify how much usable information has been collected along the trajectory. The terminal condition ensures that the trajectory results in a sufficient amount of target observation, thereby enabling successful monitoring or inspection.

At block 215, the processor 201 is configured to control the autonomous agent 103 based on the motion plan to acquire information from the targets 101a-101c. To control the autonomous agent 103, the processor 103 is configured to apply the control inputs included in the motion plan to the one or more actuators of the autonomous agent 103. The control inputs cause the one or more actuators to move the autonomous agent 103 along the trajectory. As the autonomous agent 103 traverses the trajectory, it approaches and passes near the targets 101a, 101b, and 101c while satisfying the one or more physical sensing constraints for each target. This enables the autonomous agent 103 to acquire information from each of the targets using the one or more on-board sensors. In some embodiments, a feedback controller receives the motion plan and continuously adjusts the control inputs in real time to track the trajectory, accounting for disturbances, modeling errors, or environmental uncertainty. The information acquired from the targets 101a, 101b, and 101c may include, for example, visual imagery, thermal readings, or gas concentration measurements associated with the targets 101a, 101b, and 101c.

The perception-aware motion planning process described in FIG. 2B provides several concrete technical improvements. In particular, the inclusion of the one or more temporal conditions on the information acquisition metric ensures that the system 111 generates a motion plan that results in sustained information acquisition, rather than merely transient or incidental visibility of the targets. Further, because the motion plan is generated by solving the optimization problem subject to the motion constraints of the autonomous agent 103 and the temporal conditions on the information acquisition metric, the resulting trajectory is both physically feasible and sensor aware. This integrated formulation leads to a motion plan that ensures the autonomous agent 103 moves in a manner that reliably satisfies the one or more physical sensing constraints for each target while respecting its dynamic and kinematic limitations. As a result, the autonomous agent 103 is able to collect higher-quality and complete sensor data from the targets 101a-101c, even in complex environments 100.

Moreover, because the temporal conditions require the information acquisition metric to remain active over the time interval, the optimization problem becomes structurally constrained, which helps avoid degenerate solutions where the information acquisition metric is briefly satisfied and immediately violated. This leads to a non-zero gradient with respect to motion plan parameters and results in improved numerical stability and convergence during motion plan determination, allowing system 111 to compute stable and reliable motion plans.

Additionally, because the motion plan accounts for the motion constraints, the physical sensing constraints, and the temporal conditions within a unified trajectory planning framework, the system 111 is able to produce smoother control inputs, minimize unnecessary motion, reduce energy consumption, and improve tracking performance of the autonomous agent 103 during execution of the motion plan. These combined effects result in an overall enhancement in the operational performance, robustness, and reliability of the autonomous agent 103 in real-world monitoring scenarios.

Accordingly, such a temporal-logic-based structuring of the optimization problem and the resulting physically consistent motion plan provide a technical solution to a technical problem, e.g., the problem of achieving sustained and constraint-compliant information acquisition using resource-constrained autonomous agents operating in environments with complex visibility and motion limitations.

The difference between applying or omitting the temporal conditions on the information acquisition metric is further illustrated in FIGS. 2D and 2E.

FIG. 2D illustrates a trajectory 225 determined without enforcing the temporal conditions on the information acquisition metric. FIG. 2E illustrates a trajectory 227 determined according to the perception-aware motion planning process described in FIG. 2B in which the temporal conditions are enforced in the optimization problem. As depicted in FIG. 2D, the trajectory 225 starts from an initial location 229 and terminates at a final location 231. The trajectory 225 does not include any portion that passes through valid sensing regions 250, i.e., regions of a state space of the autonomous agent 103 where the physical sensing constraints are satisfied and the information acquisition metric is non-zero. For example, with respect to targets 1, 3, and 4, a gradient of the information acquisition metric is zero, meaning an optimization problem solver solving the optimization problem is stuck and doesn't proceed. Therefore, the trajectory 225 fails to intersect valid sensing regions 250 corresponding to the targets 1, 3, and 4. Consequently, when the autonomous agent 103 traverses the trajectory 225, it fails to acquire information from the targets 1, 3, and 4.

Whereas, as shown in FIG. 2E, the trajectory 227 also starts from the initial location 229 and terminates at the final location 231. Unlike the trajectory 225, the trajectory 227 passes through respective valid sensing regions 250 corresponding to targets 1, 2, 3, 4, 5, and 6, where the information acquisition metric is non-zero with respect to the targets 1, 2, 3, 4, 5, and 6, for at least a portion of the mission time interval. As a result, the trajectory 227 ensures that the autonomous agent 103 acquires information from each of the targets 1-6 while satisfying the physical sensing constraints and the gradients of the information acquisition metric are non-zero per each target.

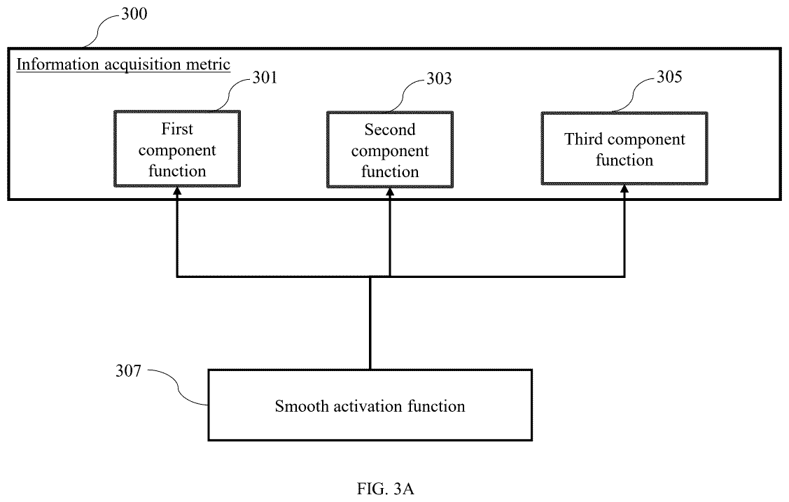

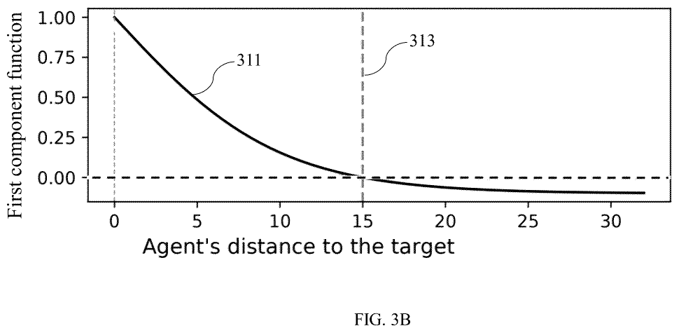

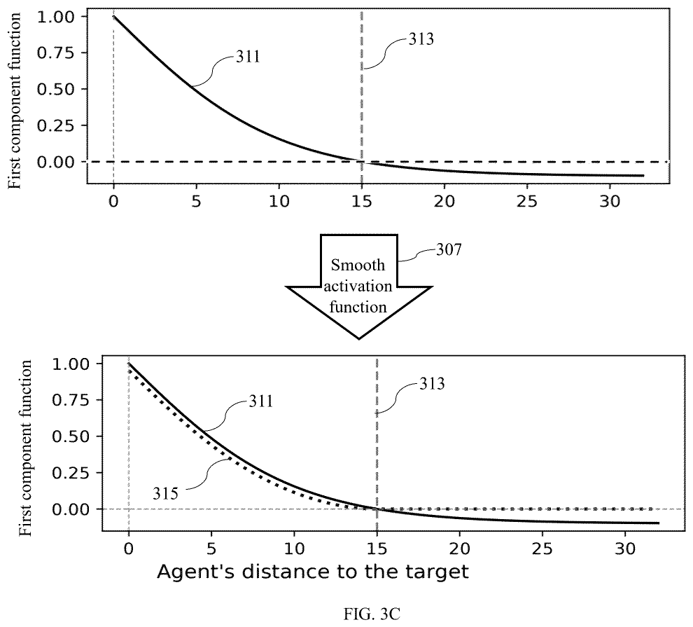

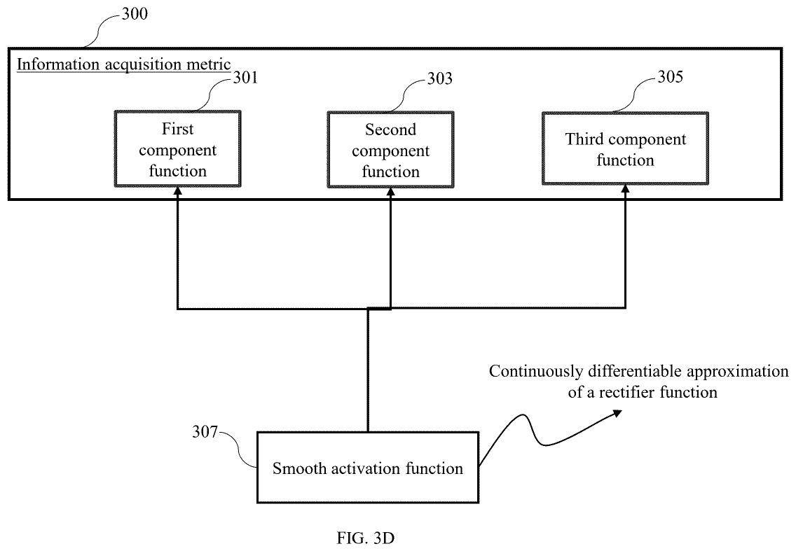

FIG. 3A illustrates an information acquisition metric 300, according to some embodiments of the present disclosure. The information acquisition metric 300 is composed of one or more component functions, e.g., a first component function 301, a second component function 303, and a third component function 305. Each component function corresponds to a different sensing physical constraint. For instance, the first component function 301 is constructed based on the range constraint, the second component function 303 is constructed based on the acquisition direction constraint, and the third component function 305 is constructed based on the field of view constraint.

Each component function quantifies an extent to which the corresponding physical sensing constraint is satisfied for a given state of the autonomous agent 1-3. Each component function is scaled such that it attains a maximum value of 1 when the respective physical sensing constraint is fully satisfied, and transitions to a value of 0 at a sensing boundary where the physical sensing constraint becomes invalid. However, beyond the sensing boundary, the component functions produce negative values.

FIG. 3B illustrates an example plot 311 of the first component function 301, which represents the range constraint, according to some embodiments. In this example, the sensing range is 15 meters; thus, a sensing boundary 313 corresponding to the range constraint 301 is at a distance of 15 meters from the target. The range constraint is satisfied when the autonomous agent 103 is positioned at or within 15 meters of the target. Accordingly, the component function 301 has positive values in an interval [0, 15] meters. However, beyond the interval [0, 15] meters (i.e., for distances greater than 15 meters), the component function 301 has negative values. Such negative values are not physically meaningful, as they imply a negative information acquisition, which lacks practical interpretation.

To address this limitation, the processor 201 is configured to apply a smooth activation function 307 to each component function. The smooth activation function 307 is constructed to ensure that the resulting smoothed component function is continuously differentiable and zero beyond the corresponding sensing boundary.

After applying the smooth activation function 307, each component function becomes zero beyond the sensory boundary of its corresponding sensing constraint. FIG. 3C illustrates the result of applying the smooth activation function 307 to the first component function 301, yielding a smoothed component function shown as curve 315. As shown, the smoothed component function has positive values when the autonomous agent 103 is within the sensing boundary 313, but has zero value when the autonomous agent 103 is outside the sensing boundary 313. By composing each component function with the smooth activation function 307, the system 111 ensures that the information acquisition metric 300 is practically interpretable.

FIG. 3D illustrates an implementation of the smooth activation function 307, according to some embodiments of the present disclosure. In some embodiments, the smooth activation function 307 applied to the component functions is a continuously differentiable approximation of a rectifier function. A rectifier function, such as a rectified linear unit (ReLU), outputs an input value when the input value is non-negative, and zero when the input value is negative. Such cutoff behavior is desirable in the present disclosure because it ensures that any contribution from infeasible sensing conditions is suppressed to zero, thereby preventing non-physical negative information acquisition values. The infeasible sensing conditions, for example, include a condition where the autonomous agent 103 is located outside of the valid sensing region.

However, the rectifier function is not differentiable at the sensing boundary, which results in the gradient used during the motion plan determination does not exist on the sensing boundary and being discontinuous across such boundary. Such gradient non-existence and discontinuity are undesirable while solving the optimization problem, as they lead to numerical instability, poor convergence, or degenerate solutions.

To overcome this limitation, the smooth activation function 307 of the present disclosure is designed as the continuously differentiable approximation of the rectifier, which preserves the cutoff behavior of the rectifier function while maintaining gradient existence and continuity across the sensing boundary. In particular, near the sensing boundary, the smooth activation function transitions gradually to zero rather than abruptly, thereby avoiding non-differentiable points. This construction ensures that the resulting the smoother component functions are non-negative, smooth, and physically interpretable while providing stable and gradient continuity to the optimization problem.

In some embodiments, the temporal conditions applied on the information acquisition metric are expressed using a Signal Temporal Logic (STL) specification. STL is a formal language for describing how real-valued signals evolve over time and is particularly well suited for specifying time-bounded, continuous-time constraints over trajectories and sensor-dependent variables.

In the context of the present disclosure, the STL specification defines the time interval during which the information acquisition metric is constrained to remain non-zero. In an embodiment, this time interval is a subinterval of the mission time interval. The mission time interval refers to the full duration over which the motion plan is executed, for example, from a start time t₀=0 seconds to an end time T=100 seconds, resulting in a mission time interval of [0,100] seconds. Within this mission time interval, an example of a time interval defined by the STL specification may be [20,40] seconds, indicating that the information acquisition metric must remain non-zero, i.e., the one or more physical sensing constraints must be satisfied, continuously between 20 and 40 seconds of the mission time interval.

In some embodiments, the STL specification defines multiple time intervals within which the information acquisition metric is constrained to remain non-zero. The multiple time intervals are defined as subintervals of the overall mission time interval. For example, the mission time interval may be defined as [0,100] seconds, and the STL specification may impose that the information acquisition metric remains non-zero over the multiple time intervals, such as [10,20], [35,45], and [70,80] seconds. This approach enables the system 111 to encode multiple sensing objectives over the course of a single mission—such as observing different targets at different times or repeatedly observing a single target. The STL specification provides a flexible and expressive way to encode the temporal conditions in a manner that is formally verifiable.

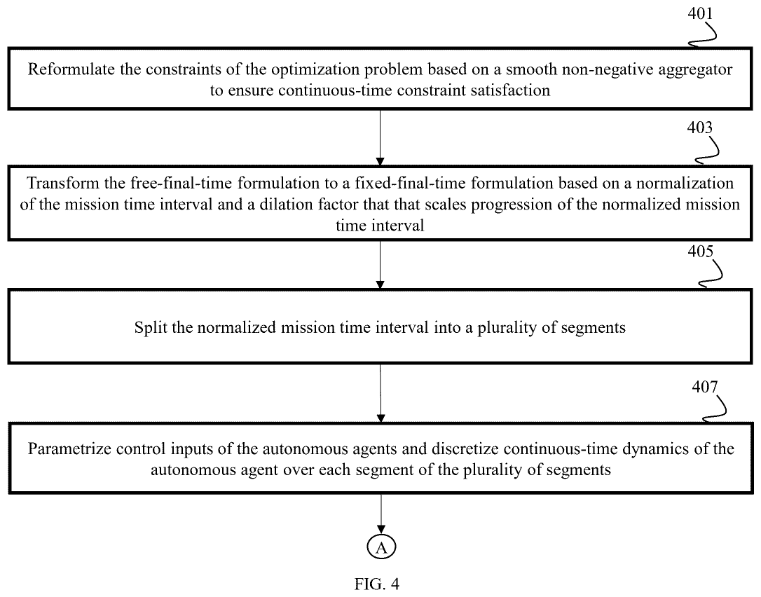

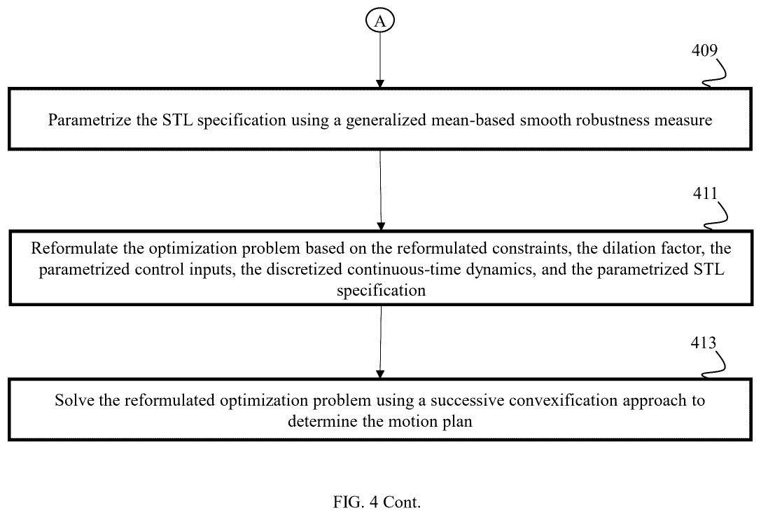

In some embodiments, the formulated optimization problem is a nonconvex problem, and the processor 201 is configured to solve the nonconvex problem using a successive convexification approach. In the successive convexification approach, the processor 201 incrementally transforms the nonconvex problem into a sequence of convex subproblems that are solved iteratively. FIG. 4 illustrates, in block form, the steps carried out by the processor 201 to implement this successive convexification approach.

FIG. 4 illustrates a block diagram for solving the optimization problem using the successive convexification approach, according to some embodiments of the present disclosure. At block 401, the processor is configured to reformulate the constraints of the optimization problem based on a smooth non-negative aggregator to ensure continuous-time constraint satisfaction. Each constraint is passed through the smooth non-negative aggregator (e.g., the smooth activation function 307) and integrated over time. An auxiliary state y(t) that accumulates any violation of constraint satisfaction is introduced, and boundary conditions y(0)=0 and y(T)=0 are imposed. If the constraints are satisfied for all time, the integral equals zero, so y(T)=0 holds; if not, any violation makes y(T)>0 which would be detected as an infeasibility of a candidate solution and results in an optimization problem solver continuing to update the candidate solution to achieve feasibility.

In some implementations, the optimization problem is a free-final-time formulation where the mission time interval is unspecified, i.e., mission end time T is unspecified. At block 403, the processor 201 is configured to transform the free-final-time formulation to a fixed-final-time formulation using dilation. The time dilation includes normalizing the mission time interval and a dilation factor that scales progression of the normalized mission time interval. The normalized mission time interval is described over a fixed interval, for example from zero to one. The dilation factor specifies how quickly or slowly the normalized mission time interval progresses relative to real mission time.

The dilation factor is treated as an optimization variable in the fixed-final-time formulation. To ensure that the dilation factor is physically meaningful and numerically stable during optimization, bounds are imposed such that the dilation factor remains greater than a minimum value greater than zero and below a maximum allowable value. Such a bounded dilation factor prevents degenerate solutions where the mission time interval either collapses to very short intervals, or even zero, or becomes unbounded. The mission time interval is then determined by integrating the dilation factor over the normalized mission time interval.

Through this time dilation, the system 111 is able to retain a fixed planning horizon for discretization and optimization while still flexibly adjusting the mission time interval, which in turn improves the tractability of the optimization problem, ensures compatibility with continuous-time constraint enforcement, and provides the autonomous agent 103 with a motion plan that is both time-scalable and sensing-aware.

At block 405, the processor 201 is configured to split the normalized mission time interval into a plurality of segments. At block 407, the processor 201 is configured to parameterize control inputs of the autonomous agent 103 and to discretize continuous-time dynamics of the autonomous agent 103 over each segment of the plurality of segments. The parameterization of the control inputs over each segment reduces the optimization problem to a tractable finite-dimensional problem. The continuous-time dynamics of the autonomous agent are discretized/enforced over each segment by using a multiple-shooting approach.

In the multiple-shooting approach, the trajectory is independently computed in each segment and continuity constraints are applied at boundaries between adjacent segments of the plurality of segments. The continuity constraints are mathematical conditions imposed at the boundaries between the adjacent segments that force a final state of one segment to exactly equal an initial state of the next segment. For example, if the autonomous agent's position and velocity at the end of segment 1 is (x, v), then the continuity constraints require that a position and a velocity at the beginning of segment 2 match those same values. By enforcing these continuity constraints, the system 111 ensures that the overall trajectory of the autonomous agent 103 is smooth, consistent, and physically feasible across the entire mission time interval.

At block 409, the processor 201 is configured to parametrize the STL specification that defines the time interval during which the information acquisition metric is constrained to remain non-zero, using a generalized mean-based smooth robustness measure (GMSR). The GMSR is a mathematical construct that provides a smooth, continuously differentiable approximation of logical operators used in the STL specification. Instead of evaluating the temporal conditions in a hard, discontinuous manner, the GMSR aggregates satisfaction values over time intervals using a generalized mean function. The parameterization of the STL specification using GMSR enables the STL specification to be expressed in a form that is smooth and differentiable.

At block 411, the processor 201 is configured to reformulate the optimization problem based on the reformulated constraints, the dilation factor, the parametrized control inputs, the discretized continuous-time dynamics, and the parametrized STL specification. At block 413, the processor 201 is configured to solve the reformulated optimization problem using a successive convexification approach to determine the motion plan. In the successive convexification approach, a series of convex approximations of the reformulated optimization problem are constructed and solved iteratively. At each iteration, linearizations and trust-region constraints are used to ensure convergence toward a solution that satisfies the original constraints of the optimization problem. This iterative procedure continues until convergence criteria are met, yielding the motion plan.

Further, the physical sensing constraints, the STL specification, the optimization problem and the reformulation of the optimization problem, are mathematically described below.

Embodiments of the present disclosure consider an agent (e.g., autonomous agent 103) with dynamics

\dot{x}(t)=F(t,x(t),u(t)) (1)

where u∈ [symbol] is an input vector, x∈ [symbol] is a state vector that includes position r∈ [symbol] , attitude Ω∈ [symbol] and possibly additional states, and the agent is subject to path constraints

g(t,x(t),u(t))≤0, (2)

h(t,x(t),u(t))=0. (3)

Given a set of targets indexed by i∈[1:nₘ], it is an objective of some embodiments to generate a trajectory from an initial state x₀ to a final state x_{f} to collect a required amount of information cₘ_{ᵢ} for each target i∈[1: nₘ] at position pₘ_{ᵢ}.

Information acquired at each time instant is modeled as dependent on a target distance, an angle from which the target is observed, and a field of view of a sensor of the agent. Thus, a nonnegative information acquisition metric, which is a function of r and Ω, is introduced to quantify the information acquired per unit time. The information acquisition metric is positive only when all of the following are satisfied: (i) the distance between the sensor and the target is less than a certain threshold, (ii) the sensor is within an acquisition cone defined by the target's position and its desired acquisition direction, and (iii) the target is within a field of view cone determined by the position and direction of the sensor. The information acquisition metric increases as the sensor gets closer to the target and aligns with the centers of the information acquisition and field of view cones.

The information acquisition metric is constructed from components mᵢ: [symbol] →[0,1] related to limitations of the sensor that affect acquisition performance.

Sensing range: Due to the distance between the agent's position and the position of the i-th target, r, pₘ_{ᵢ}∈ [symbol] ,

$${m}_{{d}_{i}} ( r ( t ) ) := 1 + {c}_{{m}_{i}} ( {( 1 + {e}^{{τ}_{{m}_{i}} {ρ}_{i} ( t )} )}^{- 1} - 0 \text{.5} ) , \qquad ( 4 a )$$

where ρᵢ(t): =∥r(t)−pₘ_{ᵢ}∥ is the distance to target i, cₘ_{ᵢ} is a scaling coefficient, and τₘ_{ᵢ} is acquisition decay rate for distance.

Acquisition direction: Due to the directions from which a target can be successfully sensed, and based on a scaled cosine similarity between a desired acquisition direction of the i-th target, dₘ_{ᵢ}, and an actual acquisition direction (̅r̅(̅t̅)̅−̅p̅ₘ̅_̅{̅ᵢ̅}̅)̅:

$${\tilde{m}}_{{a}_{i}} ( r ( t ) ) := {d}_{{m}_{i}}^{T} ( \overline{r ( t ) - {p}_{{m}_{i}}} ) \qquad ( 4 b )$$

$${m}_{{a}_{i}} ( r ( t ) ) := \frac{{\tilde{m}}_{{a}_{i}} ( r ( t ) ) - cos ( {α}_{{a}_{i}}^{d} )}{1 - cos ( {α}_{{a}_{i}}^{d} )} ,$$

where

$${α}_{{a}_{i}}^{d}$$

is an acquisition cone maximum angle;

Sensor field of view. Due to an acquisition area of the sensor and based on the scaled cosine similarity between the sensor field of view direction,

$${d}_{v} ( Ω ) := ℛ ( Ω ) {d}_{v}^{ℬ} ,$$

and the acquisition direction (̅r̅(̅t̅)̅−̅p̅ₘ̅_̅{̅ᵢ̅}̅)̅:

$${\tilde{m}}_{{v}_{i}} ( r ( t ) , Ω ( t ) ) := - {{d}_{v} ( Ω ( t ) )}^{T} ( \overline{r ( t ) - {p}_{{m}_{i}}} ) \qquad ( 4 c )$$

$${m}_{{v}_{i}} ( r ( t ) , Ω ( t ) ) := \frac{{\tilde{m}}_{{v}_{i}} ( r ( t ) , Ω ( t ) ) - cos ( {α}_{v}^{d} )}{1 - cos ( {α}_{v}^{d} )} ,$$

where [symbol] : [symbol] → [symbol] is a rotation matrix,

$${d}_{v}^{ℬ}$$

is a sensor direction in the body frame, and

$${α}_{v}^{d}$$

is a field of view maximum angle.

Thus, the information acquired each instant increases as the range decreases, as per (4a), the smaller the angular difference between desired and actual acquisition direction (4b), and the smaller the angular difference between sensor field of view direction and acquisition direction (4c).

With proper scaling, m_{d}_{ᵢ}, mₐ_{ᵢ} and mᵥ_{ᵢ} have maximum value 1, and are 0 at the border of the corresponding sensor limitation. However, past such border, they become negative, which is not meaningful since it indicates an increasingly negative information acquisition. Thus, some embodiments compose m_{d}_{ᵢ}, mₐ_{ᵢ}, mᵥ_{ᵢ} with the [symbol] -smooth function

q^{c}(x):=(max(0,x)²+c²)^{0.5}−c, where c>0. (5)

Let

$${q}^{c} ( {m}_{j} ) = {m}_{j}^{q} ,$$

for simplicity. The resulting composed functions under-approximate the functions in (4a-c) by an arbitrarily small number and are exactly zero beyond the sensor limitations, so that the sensors acquire no information beyond those.

Thus, instantaneous information acquisition is defined as q product of the modified components in (4a)-(4c), imposing that information is acquired only if all the sensor limitations are satisfied, and increases as the agent's configuration away from the constraint boundaries

$${m}_{i} ( x ( t ) ) = {\overline{m}}_{i} \cdot {m}_{{d}_{i}}^{q} ( r ( t ) ) \cdot {m}_{{a}_{i}}^{q} ( r ( t ) ) \cdot {m}_{{v}_{i}}^{q} ( r ( t ) , Ω ( t ) ) , \qquad ( 6 )$$

where m̅ᵢ denotes the maximum achievable acquisition rate for target i, x includes the position r and the attitude Ω, and the acquired information for each target evolves as

ż(t)=m(x(t))=(m₁(x(t)), . . . ,mₙ_{ₘ}(x(t))). (7)

Based on (7), some embodiments generate a trajectory for x(t), t∈[0, t_{f}] that satisfies the agent dynamics and constraints and collects a sufficient amount of information for each target,

$$z ( 0 ) = 0 , \qquad ( 8 )$$

$$z ( {t}_{f} ) \geq {c}_{m} = ( {c}_{{m}_{1}} , {c}_{{m}_{2}} , … , {c}_{{m}_{{n}_{m}}} ) .$$

To solve such a problem, some embodiments propose an optimization-based trajectory generation approach using a continuous-time successive convexification (ct-SCvx) framework.

In regions where the sensor limitations (4a-c) are not satisfied, mᵢ(x) becomes uniformly zero, resulting in a null gradient that causes convergence issues in optimization-based trajectory generation. To mitigate this issue, some embodiments ensure the existence of time intervals where mᵢ(x) and its gradient are nonzero by imposing STL specification. First, the flowing predicates are defined

$${}^{d} {φ}^{i} = ( {f}_{{d}_{i}} ( r ( t ) ) \geq 0 ) := ( {r}_{{d}_{i}}^{de} - ‖ r ( t ) - {p}_{{m}_{i}} ‖ \geq 0 ) , \qquad ( 9 )$$

$${}^{a} {φ}^{i} = ( {f}_{{a}_{i}} ( r ( t ) ) \geq 0 ) = ( {\tilde{m}}_{{a}_{i}} ( r ( t ) ) - cos ( {α}_{{a}_{i}}^{de} ) \geq 0 ) ,$$

$$\begin{matrix}{}^{v} {φ}^{i} := ( {f}_{{v}_{i}} ( r ( t ) , Ω ( t ) ) \geq 0 ) \\ := ( {\tilde{m}}_{{v}_{i}} ( r ( t ) , Ω ( t ) ) - cos ( {α}_{v}^{de} ) \geq 0 )\end{matrix} ,$$

where

$${α}_{{a}_{i}}^{de} < {α}_{{a}_{i}}^{d} and {α}_{v}^{de} < {α}_{v}^{d} .$$

If (9) hold true at time t, the corresponding functions in (4a)-(4c) are nonnegative, and thus the sensing limitations are satisfied.

Second, to ensure all conditions in (9) are satisfied in a period t_{E}_{ᵢ}>0, the following STL specification is considered

$${}^{g} {φ}^{i} := {G}_{[ 0 , {t}_{{E}_{i}} ]} ( {}^{d} {φ}^{i} ∧ {}^{a} {φ}^{i} ∧ {}^{v} {φ}^{i} ) , \qquad ( 10 )$$

where ∧ denotes conjunction, and G is the always operator, which must hold over an interval [0, t_{E}_{ᵢ}]. Finally, to ensure that (10) eventually holds within an interval [t_{S}_{ᵢ}, t_{S}_{ᵢ₊₁}], where t_{E}_{ᵢ}≤t_{S}_{ᵢ₊₁}−t_{S}_{ᵢ}, i∈[1:nₘ], the following STL specification is enforced

$${}^{f} {φ}^{i} := {F}_{[ {t}_{{s}_{i}} , {t}_{{s}_{i + 1}} - {t}_{{E}_{i}} ]} {}^{g} {φ}^{i} , \qquad ( 11 )$$

where F is an eventually operator, which must hold in an time interval [t_{S}_{ᵢ}, t_{S}_{ᵢ₊₁}−t_{E}_{ᵢ}].

Composing “eventually” and “always” in (11) ensures that, for sufficiently small

$${r}_{{d}_{i}}^{de} and {α}_{{a}_{i}}^{de} < {α}_{{a}_{i}}^{d} , {α}_{v}^{de} < {α}_{v}^{d} ,$$

if (11) is satisfied, there exists t′∈[t_{S}_{ᵢ}, t_{S}_{ᵢ₊₁}−t_{E}_{ᵢ}] such that mᵢ(x) and its gradient are nonzero for almost every t∈[t′, t′+t_{E}_{ᵢ}].

### Trajectory Generation by Continuous-Time Successive Convexification:

The trajectory generation for information acquisition is formulated as a free-final-time optimal control problem in Mayer form, with additional constraints enforcing information acquisition and satisfaction of the STL specifications

$${minimize}_{x , u , {t}_{f}} L ( {t}_{f} , x ( {t}_{f} ) ) \qquad ( 12 )$$

$$subject to \dot{x} ( t ) = F ( t , x ( t ) , u ( t ) ) a . e . t ∈ [ 0 , {t}_{f} ]$$

$$\dot{z} ( t ) = m ( x ( t ) ) a . e . t ∈ [ 0 , {t}_{f} ]$$

$$g ( t , x ( t ) , u ( t ) ) \leq 0 a . e . t ∈ [ 0 , {t}_{f} ]$$

$$h ( t , x ( r ) , u ( r ) ) = 0 a . e . t ∈ [ 0 , {t}_{f} ]$$

$$P ( x ( 0 ) , u ( 0 ) , x ( {t}_{f} ) , u ( {t}_{f} ) ) \leq 0$$

$$Q ( x ( 0 ) , u ( 0 ) , x ( {t}_{f} ) , u ( {t}_{f} ) ) = 0$$

$${c}_{m} - z ( {t}_{f} ) \leq 0$$

$$z ( 0 ) = 0$$

$$( x ( t ) , 0 ) ⊨ {}^{f} {φ}^{i} ∀ i ∈ [ 1 : {n}_{m} ]$$

where L is a terminal cost function, g and h are the path constraints, P and Q are boundary condition constraint functions.

Next, steps for solving (12) using the continuous-time successive convexification approach, are described.

### Continuous-Time Constraint Satisfaction

For ensuring the satisfaction of the path constraints in continuous time,

$$g ( t , x ( t ) , u ( t ) ) \leq 0 , h ( t , x ( t ) , u ( t ) ) = 0 a . e . t ∈ [ 0 , {t}_{f} ] ⇔ {\int }_{0}^{{t}_{f}} {q}^{c} ( g ( t , x ( t ) , u ( t ) ) ) + {q}^{d} ( h ( t , x ( t ) , u ( t ) ) ) d t = 0 , \qquad ( 13 )$$

where q^{c} is the same as in (5) and

q^{d}(x):=(x²+d²)^{0.5}−d, where d>0. (14)

Thus, an auxiliary state y to accumulate violation of the path constraints is introduced

\dot{y}(t)=1^{T}q^{c}(g(t,x(t),u(t)))+1^{T}q^{d}(h(t,x(t),u(t))), (15)

and impose boundary conditions:

y(0)=0,y(t_{f})=0. (16)

Including the cumulative constraint violation and the information acquisition, augmented dynamics are given by

$$\begin{matrix}{x}_{a} ( t ) := ( x ( t ) , y ( t ) , z ( t ) ) , \\ {\dot{x}}_{a} ( t ) := {F}_{a} ( t , {x}_{a} ( t ) , u ( t ) ) \\ := [ \begin{matrix}F ( t , x ( t ) , u ( t ) ) \\ {1}^{⊤} {q}^{c} ( g ( t , x ( t ) , u ( t ) ) ) + {1}^{⊤} {q}^{d} ( h ( t , x ( t ) , u ( t ) ) ) \\ m ( x ( ( t ) )\end{matrix} ] .\end{matrix} \qquad ( 17 )$$

### 2. Time-Dilation

The free-final-time optimal control problem in (12) is transformed into an equivalent fixed-final-time formulation using the time-dilation. Define a strictly increasing, continuously differentiable function \tilde{t}: [0,1]→ [symbol] that satisfies \tilde{t}(0)=0 and \tilde{t}(1)=t_{f}. A rate of time flow, referred to as the dilation factor, is s(τ)=d\tilde{t}(τ)/dτ={combining ring above (\tilde{t})}(τ) for τ∈[0,1], where s(τ) is an additional decision variable in optimal control problem, treated as an additional control input.

With respect to τ, derivatives are denoted as □̊:=d□/dτ and the state and input vectors are \tilde{x}(τ):=(xₐ(\tilde{t}(τ)), \tilde{t}(τ)), ũ(τ):=(u(\tilde{t}(τ)), s(τ)), where the additional (last) component of the state tracks time evolution, and the dilation factor is added as an input. With respect to τ, the dynamics are

$$\begin{matrix}{x}^{\mathring{\sim}} ( τ ) = [ \begin{matrix}{\dot{x}}_{a} ( t ) \\ 1\end{matrix} ] \frac{d \tilde{t} ( τ )}{d τ} = f ( \tilde{x} ( τ ) , \tilde{u} ( τ ) ) \\ = [ \begin{matrix}{F}_{a} ( \tilde{t} ( τ ) , {x}_{a} ( \tilde{t} ( τ ) ) , u ( \tilde{t} ( τ ) ) ) \\ 1\end{matrix} ] s ( τ ) ,\end{matrix} \qquad ( 18 )$$

where now the final time is fixed, and t_{f}=\tilde{t}(1) is still free and dependent on the additional control input s.

### 3. Problem Discretization

Discretize [0,1] into N uniformly spaced node points 0=τ₁< . . . <τ_{N}=1 with step size Δτ=1/(N−1). The control input is parameterized by a first-order hold as ũ(τ)=ũₖ(τₖ₊₁−τ)/Δτ+ũₖ₊₁(τ−τₖ)/Δτ for τ∈[τₖ, τₖ₊₁] and k∈[1: N−1]. With the state and control values at node points, xₖ, uₖ, k∈ [symbol] as decision variables, the system dynamics (18) is discretized using multiple-shooting

$${\tilde{x}}_{k + 1} = {\tilde{x}}_{k} + {\int }_{{τ}_{k}}^{{τ}_{k + 1}} f ( {\tilde{x}}^{{}_{k}} ( τ ) , \tilde{u} ( τ ) ) d τ , \qquad ( 19 )$$

where \tilde{x}^{k}(τ) denotes a solution of the dynamics starting at \tilde{x}ₖ and driven by ũ(τ). Thus, (19) is expressed as \tilde{x}ₖ₊₁=fₖ(\tilde{x}ₖ, ũₖ, ũₖ₊₁). To avoid degenerate solutions, a lower bound is imposed on the dilation factor ^{s}E(ũₖ₊ₗ−ũₖ)≥sₘᵢₙ, where sₘᵢₙ>0 is the shortest time between nodes. Here, ^{□} E ⋄ denotes extraction of the □-component from vector ⋄. The boundary condition in (16) is relaxed to ^{y}E(\tilde{x}ₖ₊₁−\tilde{x}ₖ)≤∈_{LICQ}, where ∈_{LICQ}>0 is a constant that ensures linear independence constraint qualification.

### 4. Parametrization of the STL Specifications

The STL specification (11) is parameterized using GMSR. Functions for parameterizing conjunction and disjunction operators,

$${}^{⋀} {h}_{p , w}^{c} and {}^{⋁} {h}_{p , w}^{c} ,$$

respectively, are

$${}^{⋀} {h}_{p , w}^{c} ( a ) := {( {M}_{0 , w}^{c} ( {\vert a \vert}_{+}^{2} ) )}^{\frac{1}{2}} - {( {M}_{p , w}^{c} ( {\vert a \vert}_{-}^{2} ) )}^{\frac{1}{2}} , \\ {}^{⋁} {h}_{p , w}^{c} ( a ) := - {}^{⋁} {h}_{p , w}^{c} ( - a ) , \qquad ( 20 )$$

$$where$$

$$\begin{matrix}{M}_{0 , w}^{c} ( b ) := {( {c}^{{1}^{T} w} + {\prod }_{i = 1}^{n} {b}_{i}^{{w}_{i}} )}^{1 / {1}^{T} w} , \\ {M}_{p , w}^{c} ( b ) := {( {c}^{p} + \frac{1}{{1}^{T} w} {\sum }_{i = 1}^{n} {w}_{i} {b}_{i}^{p} )}^{1 / p} ,\end{matrix} \qquad ( 21 )$$

a∈ [symbol] ,b∈ [symbol] ,c∈ [symbol] ,p∈ [symbol] ,w∈ [symbol] .

The always specification (10) is parameterized as

$${Γ}_{c , p , w}^{{g}_{φ} i} ( \tilde{x} , k ) = {}^{⋀} {h}_{p , w}^{c} ( ( {}^{⋀} {h}_{p , w}^{c} ( {f}_{{s}_{i}} ( {r}_{k} , {Ω}_{k} ) ) , \\ ⋮ {}^{⋀} {h}_{p , w}^{c} ( {f}_{{s}_{i}} ( {r}_{k + {n}_{{E}_{i}}} , {Ω}_{k + {n}_{{E}_{i}}} ) ) ) ) \qquad ( 22 )$$

where fₛ_{ᵢ}(rₖ,Ωₖ):=(f_{d}_{ᵢ}(rₖ), fₐ_{ᵢ}(rₖ), fᵥ_{ᵢ}(rₖ,Ωₖ)) for k∈[1: N], rₖ and Ωₖ denote values of r(\tilde{t}(τₖ)) and Ω(\tilde{t}(τₖ)), respectively, and n_{E}_{ᵢ}∈ [symbol] is a number of node points required to satisfy the ^{g}φⁱ specification and chosen such that

$$\tilde{t} ( {τ}_{k + {n}_{{E}_{i}}} ) - \tilde{t} ( {τ}_{k} ) \geq {t}_{{E}_{i}} .$$

The eventually specification (11) is parameterized as

$${Γ}_{c , p , w}^{{f}_{φ} i} ( \tilde{x} , 0 ) = {}^{⋁} {h}_{p , w}^{c} ( ( {Γ}_{c , p , w}^{{g}_{φ} i} ( \tilde{x} , {k}_{{S}_{i}} ) , \\ ⋮ {Γ}_{c , p , w}^{{g}_{φ} i} ( \tilde{x} , {k}_{{S}_{i + 1}} - {n}_{{E}_{i}} - 1 ) ) ) \qquad ( 23 )$$

where k_{S}_{ᵢ} and k_{S}_{ᵢ₊₁} are indices of the node points defining an interval [k_{S}_{ᵢ}: k_{S}_{ᵢ₊}−1], over which the ^{g}φⁱ specification must be satisfied. Since positive side of

$${Γ}_{c , p , w}^{{f}_{φ} i}$$

is irrelevant, some embodiments consider a constraint given as

$${\tilde{Γ}}_{c , p , w}^{{f}_{φ} i} ( \tilde{x} , 0 ) \geq 0 , \\ {\tilde{Γ}}_{c , p , w}^{{f}_{φ} i} ( \tilde{x} , 0 ) = {\prod }_{k = {k}_{{S}_{i}}}^{{k}_{{S}_{i + 1}} - {n}_{E} - 1} {\sum }_{j = 0}^{{n}_{{E}_{i}}} ( {1}^{⊤} {q}^{c} ( {f}_{{s}_{i}} ( {r}_{k + j} , {Ω}_{k + j} ) ) ) . \qquad ( 24 )$$

The constraint (24) is enforced only at the node points. However, since

$${α}_{{a}_{i}}^{de} < {α}_{{a}_{i}}^{d} , {α}_{v}^{de} < {α}_{v}^{d} ,$$

continuity of the trajectory ensures that satisfying

$${\tilde{Γ}}_{c , p , w}^{{f}_{φ} i} ( \tilde{x} , 0 ) \geq 0$$

for sufficiently small

$${α}_{{d}_{i}}^{de}$$

guarantees existence of t′∈[0, t_{f}] and δ>0 such that mᵢ(x(t)) and its gradient are nonzero almost everywhere in (t′−δ, t′+δ), facilitating convergence of gradient-based methods.

### Numerical Problem and Solution

The procedure detailed under sections 1-4 above results in a reformulation of the optimal control problem (12), incorporating discretized dynamics, including time-dilation, continuous-time constraint satisfaction, parameterized control inputs, and STL specifications. Non-convex constraints are treated as “soft” constraints by applying exact penalty functions, e.g., |⋅|₊ and ∥⋅∥₁ to the constraint violations, resulting in the optimalization problem

$$\begin{matrix}{minimize}_{{\tilde{x}}_{k} , {\tilde{u}}_{k} , k ∈ [ 1 : N ]} & L ( {}^{t} E {\tilde{x}}_{N} , {}^{x} E {\tilde{x}}_{N} ) + \\ & {w}_{dyn} {\sum }_{k = 1}^{N - 1} {‖ {\tilde{x}}_{k + 1} - {f}_{k} ( {\tilde{x}}_{k} , {\tilde{u}}_{k} , {\tilde{u}}_{k + 1} ) ‖}_{1} + \\ & {{w}_{iq} \vert P {(}^{x} E {\tilde{x}}_{1} , {}^{u} E {\tilde{u}}_{1} , {}^{x} E {\tilde{x}}_{N} , {}^{u} E {\tilde{u}}_{N} ) \vert}_{+} + \\ & {w}_{e q} {‖ Q ( {}^{x} E {\tilde{x}}_{1} , {}^{u} {Eũ}_{1} , {}^{x} E {\tilde{x}}_{N} , {}^{u} {Eũ}_{N} ) ‖}_{1} + \\ & {w}_{s t l} {\sum }_{i = 1}^{{n}_{m}} {\vert - {\tilde{Γ}}_{c , p , w}^{{f}_{φ} i} ( \tilde{x} , 0 ) \vert}_{+} \\ subject to & {s}_{min} \leq {}^{s} E ( {\tilde{u}}_{k + 1} - {\tilde{u}}_{k} ) \\ & {}^{y} E ( {\tilde{x}}_{k + 1} - {\tilde{x}}_{k} ) \leq {ϵ}_{LICQ} \\ & {c}_{m} \leq {}^{z} E {\tilde{x}}_{N} \\ & {}^{z} E {\tilde{x}}_{1} = 0\end{matrix} \qquad ( 25 )$$

The optimization problem in (25) is formulated as

$${minimize}_{Z ∈ 𝒵} {J}_{nl} ( Z , ) := G ( Z ) + {w}_{e p} H ( C ( Z ) ) \qquad ( 26 )$$

where Z=(\tilde{x}₁, . . . , \tilde{x}_{N}, ũ₁, . . . , ũ_{N}), a convex set [symbol] encodes the constraints in (25), and convex function G and composition H∘C encode cost, penalized dynamics, boundary conditions, and parameterized STL specifications.

The formulated optimization problem (26) is solved using a prox-linear method that finds a stationary point of (26) by solving a sequence of convex subproblems. At iteration j+1, it solves

$${minimize}_{Z ∈ 𝒵} {J}_{lin} ( Z , {Z}^{j} , {w}_{prox} ) := G ( Z ) + {w}_{e p} H ( C ( {Z}^{j} ) + ∇ C ( {Z}^{j} ) ( Z - {Z}^{j} ) ) + \frac{{w}_{prox}}{2} {‖ Z - {Z}^{j} ‖}_{2}^{2} , \qquad ( 27 )$$

where Z^{j} is a previous iterate. With a suitably chosen proximal weight wₚᵣₒₓ, a sequence Z^{j} converges, and if a limit point is feasible for hard constrained discretized optimal control problem, it satisfies KKT conditions.

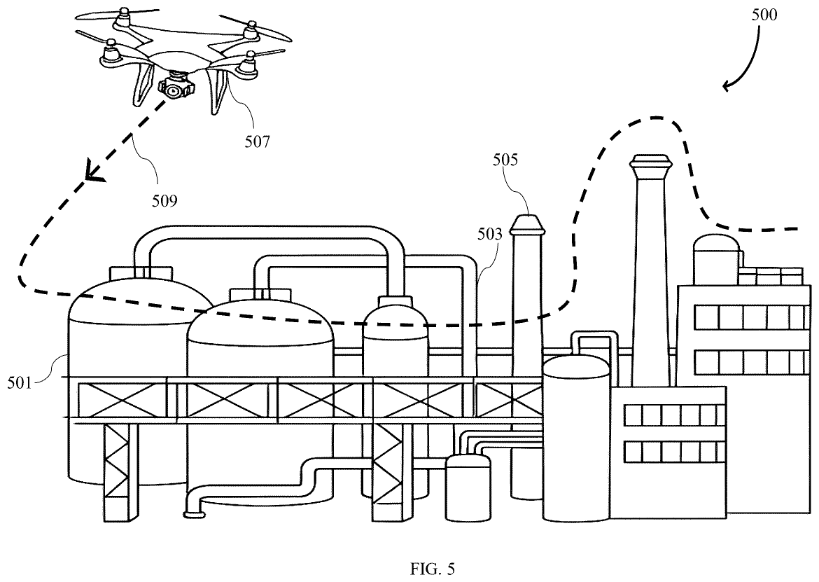

In various embodiments, the disclosed system 111 may be applied across different operational domains where autonomous agents are tasked with acquiring information from distributed targets under sensing and motion constraints. Depending on the deployment environment, the autonomous agent may take the form of an aerial vehicle operating in industrial plants, a marine vehicle navigating underwater settings, or a ground vehicle traversing warehouses or factories. In each case, the system 111 determines a motion plan that guides the autonomous agent along a trajectory designed to satisfy both physical sensing constraints and the temporal conditions, thereby ensuring that sufficient, reliable information is collected from relevant targets. Illustrative examples of such applications are described below with reference to FIGS. 5-7.

For instance, in some embodiments, the autonomous agent 103 is the aerial vehicle, the environment 100 is an industrial plant, the targets include infrastructure assets of the industrial facility. The processor 201 of the system 111 is configured to control the aerial vehicle according to the motion plan to acquire information from the infrastructure assets for inspection, as described below in FIG. 5.

FIG. 5 illustrates an embodiment of the system 111 applied in an industrial inspection use case, according to some embodiments of the present disclosure. FIG. 5 shows an industrial plant 500 including various infrastructure assets such as tanks 501, pipelines 503, and chimneys 505. An aerial vehicle 507 is configured with one or more on-board sensors to acquire information from the infrastructure assets. The aerial vehicle 507 is communicatively coupled to the system 111 (not shown in figure). A motion plan including a trajectory 509 is determined by the system 111 according to the perception-aware motion planning process described in FIG. 2B. The trajectory 509 passes across or near the tanks 501, pipelines 503, and chimneys 505. The system 111 is further configured to control the aerial vehicle 507 to traverse the trajectory 509, such that the aerial vehicle 507 passes across or near the tanks 501, the pipelines 503, and the chimneys 505 while satisfying the physical sensing constraints and the temporal conditions.

Thereby, while traversing the trajectory 509, the one or more on-board sensors of the aerial vehicle 507 acquire reliable information from the infrastructure assets of the industrial plant 500 for a portion of the mission time interval. The acquired information may include visual imagery, thermal profiles, gas concentration levels, or structural data of the tanks 501, the pipelines 503, and the chimneys 505. Such acquired information can be processed for inspection, e.g., detect anomalies such as corrosion, leakage, overheating, or structural degradation, enabling timely maintenance and ensuring safe and efficient operation of the industrial plant 500.

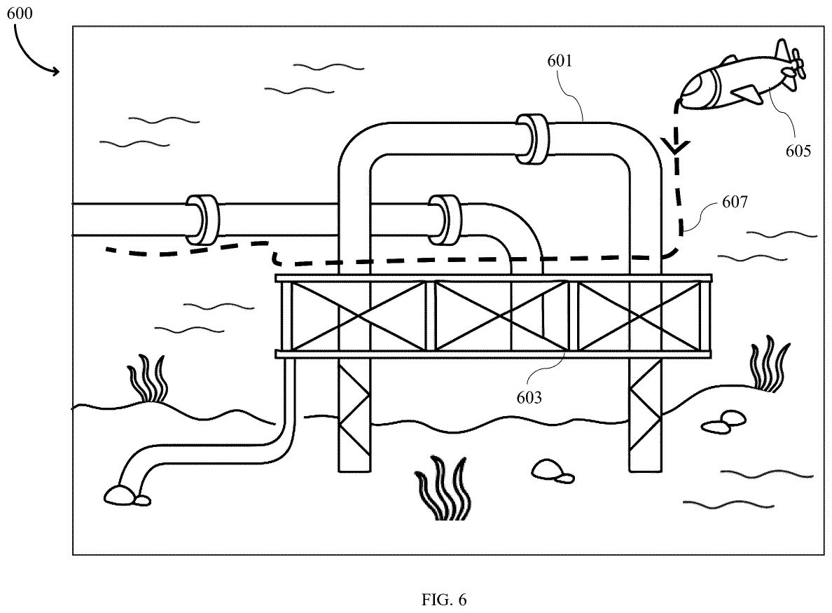

In some other embodiments, the autonomous agent 103 is the marine vehicle, the environment 100 is an underwater setting, and the targets include underwater structures. The processor 201 of the system 111 is configured to control the marine vehicle according to the motion plan to acquire information from the underwater structures for inspection, as described below in FIG. 6.

FIG. 6 illustrates an embodiment of the system 111 applied in an underwater inspection use case, according to some embodiments of the present disclosure. FIG. 6 shows an underwater setting 600 including underwater structures such as pipelines 601 and support structure 603. A marine vehicle 605 (autonomous underwater vehicle, AUV) is configured with one or more on-board sensors to acquire information from the underwater structures. The marine vehicle 605 is communicatively coupled to the system 111 (not shown in figure). A motion plan including a trajectory 607 is determined by the system 111 according to the perception-aware motion planning process described in FIG. 2B. The trajectory 607 passes near or across the pipelines 601 and the support structure 603. The system 111 is further configured to control the marine vehicle 605 to traverse the trajectory 607, such the marine vehicle 605 passes near or across the pipelines 601 and the support structure 603 while satisfying the physical sensing constraints and the temporal conditions.

Thereby, while traversing the trajectory 607, the one or more on-board sensors of the marine vehicle 605 acquire reliable information from the underwater structures for a portion of the mission time interval. The acquired information may include visual inspection imagery, sonar profiles, or leak detection data. Such acquired information can be processed for inspection, e.g., to detect anomalies such as cracks, corrosion, marine growth, or leakage, enabling timely maintenance and ensuring safe and efficient operation of the underwater structures.

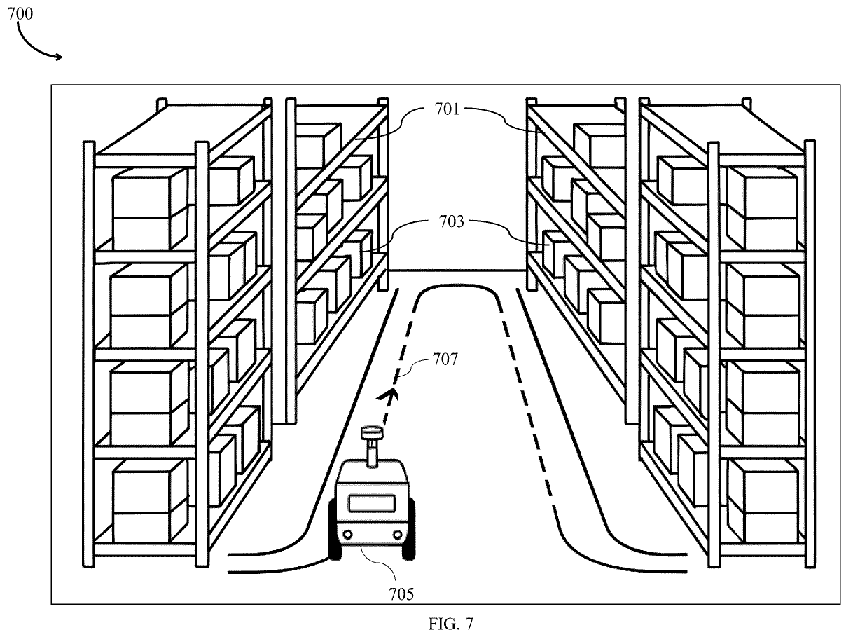

In some other embodiments, the autonomous agent 103 is the ground vehicle, the environment 100 is a warehouse, and the targets include items of stored inventory. The processor 201 of the system 111 is configured to control the ground vehicle according to the motion plan to acquire information from the stored inventory items, as described below in FIG. 7.

FIG. 7 illustrates an embodiment of the system 111 applied in a warehouse inventory management use case, according to some embodiments of the present disclosure. FIG. 7 shows a warehouse 700 that includes racks 701 storing various inventory items 703. A ground vehicle 705, equipped with one or more on-board sensors such as optical cameras or barcode scanners, is communicatively coupled to the system 111 (not shown in figure). A motion plan including a trajectory 707 is determined by the system 111 according to the perception-aware motion planning process described in FIG. 2B. The trajectory 707 passes along aisles and near the racks 701.

The system 111 is further configured to control the ground vehicle 705 to traverse the trajectory 707, such that the ground vehicle 705 passes across or near the racks 701 while satisfying the physical sensing constraints and the temporal conditions. Thereby, while traversing the trajectory 707, the one or more on-board sensors of the ground vehicle 705 acquire reliable information from the inventory items 703 for a portion of the mission time interval.

The acquired information may include visual imagery of barcodes or labels, dimensional measurements, or weight data associated with the inventory items 703. Such acquired information may be processed for inspection and inventory management tasks, including verifying stock levels, detecting misplaced or missing items, identifying damaged goods, and updating warehouse databases in real time. This enables efficient, accurate, and automated warehouse operation while reducing reliance on manual inspection.

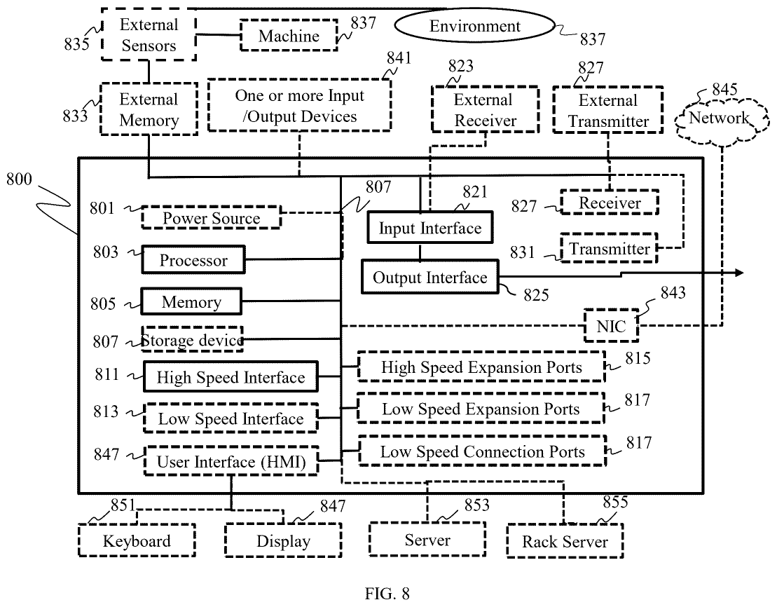

FIG. 8 is a schematic illustrating by non-limiting example a computing apparatus for implementing the methods and the systems of the present disclosure. The computing device 800 can include a power source 801, a processor 803, a memory 805, a storage device 807, all connected to a bus 809. Further, a high-speed interface 811, a low-speed interface 813, high-speed expansion ports 815 and low speed connection ports 817, can be connected to the bus 809. In addition, a low-speed expansion port 819 is in connection with the bus 809. Further, an input interface 821 can be connected via the bus 809 to an external receiver 823 and an output interface 825. A receiver 827 can be connected to an external transmitter 829 and a transmitter 831 via the bus 809. Also connected to the bus 809 can be an external memory 833, external sensors 835, machine(s) 837, and an environment 839. Further, one or more external input/output devices 841 can be connected to the bus 809. A network interface controller (NIC) 843 can be adapted to connect through the bus 809 to a network 845, wherein data or other data, among other things, can be rendered on a third-party display device, third-party imaging device, and/or third-party printing device outside of the computer device 800.

The memory 805 can store instructions that are executable by the computer device 800, historical data, and any data that can be utilized by the methods and systems of the present disclosure. The memory 805 can include random access memory (RAM), read only memory (ROM), flash memory, or any other suitable memory systems. The memory 805 can be a volatile memory unit or units, and/or a non-volatile memory unit or units. The memory 805 may also be another form of computer-readable medium, such as a magnetic or optical disk.

The storage device 807 can be adapted to store supplementary data and/or software modules used by the computer device 800. For example, the storage device 807 can store historical data and other related data as mentioned above regarding the present disclosure. Additionally, or alternatively, the storage device 807 can store historical data like data as mentioned above regarding the present disclosure. The storage device 807 can include a hard drive, an optical drive, a thumb-drive, an array of drives, or any combinations thereof. Further, the storage device 807 can contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, the processor 803), perform one or more methods, such as those described above.

The computing device 800 can be linked through the bus 809, optionally, to a display interface or user Interface (HMI) 847 adapted to connect the computing device 800 to a display device 849 and a keyboard 851, wherein the display device 849 can include a computer monitor, camera, television, projector, or mobile device, among others. In some implementations, the computer device 800 may include a printer interface to connect to a printing device, wherein the printing device can include a liquid inkjet printer, solid ink printer, large-scale commercial printer, thermal printer, UV printer, or dye-sublimation printer, among others.

The high-speed interface 811 manages bandwidth-intensive operations for the computing device 800, while the low-speed interface 813 manages lower bandwidth-intensive operations. Such allocation of functions is an example only. In some implementations, the high-speed interface 811 can be coupled to the memory 805, the user interface (HMI) 847, and to the keyboard 851 and the display 849 (e.g., through a graphics processor or accelerator), and to the high-speed expansion ports 815, which may accept various expansion cards via the bus 809. In an implementation, the low-speed interface 813 is coupled to the storage device 807 and the low-speed expansion ports 817, via the bus 809. The low-speed expansion ports 817, which may include various communication ports (e.g., USB, Bluetooth, Ethernet, wireless Ethernet) may be coupled to the one or more input/output devices 841. The computing device 800 may be connected to a server 853 and a rack server 855. The computing device 800 may be implemented in several different forms. For example, the computing device 800 may be implemented as part of the rack server 855.

The description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

We claim:

1. A system for controlling an autonomous agent to acquire information from at least one target in an environment, comprising: a processor; and a memory having instructions stored thereon that, when executed by the processor, cause the system to:
define an information acquisition metric that is a function of a state of the autonomous agent and is configured to indicate a non-zero value when one or more physical sensing constraints are satisfied, the one or more physical sensing constraints comprising at least one of a range constraint, an acquisition direction constraint, or a field of view constraint;
apply one or more temporal conditions on the information acquisition metric, the one or more temporal conditions indicating that the information acquisition metric is to satisfy the one or more physical sensing constraints over a time interval;
formulate and solve a trajectory optimization problem subject to constraints to determine a motion plan for the autonomous agent, wherein the constraints include a motion constraint associated with the autonomous agent, a terminal condition based on an accumulated value of the information acquisition metric, and the one or more temporal conditions; and
control, based on the motion plan, the autonomous agent in the environment to acquire the information from the at least one target in the environment.

2. The system of claim 1, wherein the motion plan includes a trajectory representing a time-varying state of the autonomous agent over a mission time interval, and control inputs configured to execute the trajectory.

3. The system of claim 1, wherein the range constraint that is satisfied when a distance between the autonomous agent and the at least one target is less than or equal to a sensing range.

4. The system of claim 1, wherein the acquisition direction constraint is satisfied when an angle between (i) a direction from the autonomous agent to the at least one target and (ii) a predefined acquisition direction associated with the at least one target is within a predefined angular range.

5. The system of claim 1, wherein the field of view constraint is satisfied when the at least one target lies within a predefined angular range defining a field of view of the autonomous agent.

6. The system of claim 1, wherein the information acquisition metric is composed of one or more component functions, each corresponding to a different sensing constraint, and wherein the processor is further configured to apply a smooth activation function to each component function.

7. The system of claim 6, wherein each composed function resulting from application of the smooth activation function has zero value outside a sensing boundary of the corresponding physical sensing constraint.

8. The system of claim 6, wherein the smooth activation function is a continuously differentiable approximation of a rectifier function configured to suppress contributions from infeasible sensing conditions while preserving gradient continuity.

9. The system of claim 1, wherein the one or more temporal conditions are specified using Signal Temporal Logic (STL) specification that defines the time interval during which the information acquisition metric is constrained to remain non-zero.

10. The system of claim 9, wherein the optimization problem is a free-final-time formulation where a mission time interval is unspecified, and wherein, to solve the trajectory optimization problem subject to the constraints, the processor is further configured to:
reformulate the constraints of the optimization problem based on a smooth non-negative aggregator to ensure continuous-time constraint satisfaction;
transform the free-final-time formulation to a fixed-final-time formulation based on a normalization of the mission time interval and a dilation factor that scales progression of the normalized mission time interval;
split the normalized mission time interval into a plurality of segments;
parametrize control inputs of the autonomous agents and discretize continuous-time dynamics of the autonomous agent over each segment of the plurality of segments;
parametrize the STL specification using a generalized mean-based smooth robustness measure;
reformulate the optimization problem based on the reformulated constraints, the dilation factor, the parametrized control inputs, the discretized continuous-time dynamics, and the parametrized STL specification; and
solve the reformulated optimization problem using a successive convexification approach to determine the motion plan.

11. The system of claim 10, wherein the dilation factor is bounded and treated as an optimization variable fixed-final-time formulation, and wherein the mission time interval is determined by integrating the dilation factor over the normalized mission time interval.

12. The system of claim 10, wherein the processor is further configured to discretize the continuous-time dynamics of the autonomous agent over each segment by using a multiple-shooting approach.

13. The system of claim 1, wherein the autonomous agent is configured to acquire the information from the at least one target using one or more on-board sensors, the one or more on-board sensors include an optical camera, a radar, an ultrasonic sensor, a gas sensor, or a hyperspectral imager.

14. The system of claim 1, wherein the autonomous agent is an aerial vehicle, the environment is an industrial plant, the at least one target includes an infrastructure asset of the industrial facility, and wherein the processor is further configured to control the aerial vehicle according to the motion plan to acquire information from the infrastructure asset for inspection.

15. The system of claim 1, wherein the autonomous agent is a marine vehicle, the environment is an underwater setting, the at least one target includes an underwater structure, and wherein the processor is further configured to control the marine vehicle according to the motion plan to acquire information from the subsea structure for inspection.

16. The system of claim 1, wherein the autonomous agent is a ground vehicle, the environment is a warehouse, the at least one target includes an item of stored inventory, and wherein the processor is further configured to control the ground vehicle according to the motion plan to acquire information from the item of stored inventory.

17. A method for controlling an autonomous agent to acquire information from at least one target in an environment, the method comprising:
defining an information acquisition metric that is a function of a state of the autonomous agent and is configured to indicate a non-zero value when one or more physical sensing constraints are satisfied, the one or more physical sensing constraints comprising at least one of a range constraint, an acquisition direction constraint, or a field of view constraint;
applying one or more temporal conditions on the information acquisition metric, the one or more temporal conditions indicating that the information acquisition metric is to satisfy the one or more physical sensing constraints over a time interval;
formulating and solving a trajectory optimization problem subject to constraints to determine a motion plan for the autonomous agent, wherein the constraints include a motion constraint associated with the autonomous agent, a terminal condition based on an accumulated value of the information acquisition metric, and the one or more temporal conditions; and
controlling, based on the motion plan, the autonomous agent in the environment to acquire the information from the at least one target in the environment.

18. The method of claim 17, wherein the motion plan includes a trajectory representing a time-varying state of the autonomous agent over a mission time interval, and control inputs configured to execute the trajectory.

19. The method of claim 17, wherein the information acquisition metric is composed of one or more component functions, each corresponding to a different sensing constraint, and wherein the method further comprises applying a smooth activation function to each component function.

20. A non-transitory computer-readable storage medium embodied thereon a program executable by a processor for performing a method for controlling an autonomous agent to acquire information from at least one target in an environment, the method comprising:
defining an information acquisition metric that is a function of a state of the autonomous agent and is configured to indicate a non-zero value when one or more physical sensing constraints are satisfied, the one or more physical sensing constraints comprising at least one of a range constraint, an acquisition direction constraint, or a field of view constraint;
applying one or more temporal conditions on the information acquisition metric, the one or more temporal conditions indicating that the information acquisition metric is to satisfy the one or more physical sensing constraints over a time interval;
formulating and solving a trajectory optimization problem subject to constraints to determine a motion plan for the autonomous agent, wherein the constraints include a motion constraint associated with the autonomous agent, a terminal condition based on an accumulated value of the information acquisition metric, and the one or more temporal conditions; and
controlling, based on the motion plan, the autonomous agent in the environment to acquire the information from the at least one target in the environment.
